(19) United States
(12) Patent Application Publication
(10) Pub. No.: US 2017/0117590 A1
(43) Pub. Date: Apr. 27, 2017

(54) CATHODE COMPOSITE MATERIAL, LITHIUM ION BATTERY USING THE SAME AND METHOD FOR MAKING THE SAME

(71) Applicants: JIANGSU HUADONG INSTITUTE OF LI-ION BATTERY CO., LTD., Jiangsu (CN); TSINGHUA UNIVERSITY, Beijing (CN)

(72) Inventors: Guan-Nan Qian, Beijing (CN); Xiang-Ming He, Beijing (CN); Li Wang, Beijing (CN); Yu-Ming Shang, Beijing (CN); Jian-Jun Li, Beijing (CN); Zhen Liu, Beijing (CN); Jian Gao, Beijing (CN); Hong-Sheng Zhang, Beijing (CN); Yao-Wu Wang, Beijing (CN)

(73) Assignees: JIANGSU HUADONG INSTITUTE OF LI-ION BATTERY CO., LTD., Jiangsu (CN); TSINGHUA UNIVERSITY, Beijing (CN)

(21) Appl. No.: 15/401,480

(22) Filed: Jan. 9, 2017

Related U.S. Application Data
(63) Continuation of application No. PCT/CN2015/081511, filed on Jun. 16, 2015.

(30) Foreign Application Priority Data
Jul. 9, 2014 (CN) 201410323788.X

(51) Int. Cl. H01M 10/42; C08G 73/12; H01M 4/525; H01M 10/0525; H01M 4/505

(52) U.S. Cl. CPC H01M 10/4235; H01M 10/0525; H01M 4/505; H01M 4/525; C08G 73/121

(57) ABSTRACT

A cathode composite material is disclosed. The cathode composite material comprises a cathode active material and a polymer composed with the cathode active material. The polymer is obtained by polymerizing a maleimide type monomer with an organic diamine type compound. The maleimide type monomer comprises at least one of a maleimide monomer, a bismaleimide monomer, a multimaleimide monomer and a maleimide type derivative monomer. A method for making the cathode composite material and a lithium ion battery are also disclosed.

### CROSS-REFERENCE TO RELATED APPLICATIONS

This application claims all benefits accruing under 35 U.S.C. §119 from China Patent Application No. 201410323788.X, filed on Jul. 9, 2014 in the State Intellectual Property Office of China, the content of which is hereby incorporated by reference. This application is a continuation under 35 U.S.C. §120 of international patent application PCT/CN2015/081511 filed on Jun. 16, 2015, the content of which is also hereby incorporated by reference.

### FIELD

The present disclosure relates to cathode composite materials, and methods for making the same, and lithium ion batteries using the same.

### BACKGROUND

With the rapid development and generalization of portable electronic products, there is an increasing need for lithium ion batteries due to their excellent performance and characteristics such as high energy density, long cyclic life, no memory effect, and light pollution when compared with conventional rechargeable batteries. However, the explosion of lithium ion batteries for mobile phones and laptops has occurred often in recent years, which has aroused public attention to the safety of the lithium ion batteries. The lithium ion batteries could release a large amount of heat if overcharged/discharged, short-circuited, or at large current for long periods time, which could cause burning or explosion due to runaway heat. Stricter safety standards are required in some applications such as electric vehicles.

### BRIEF DESCRIPTION OF THE DRAWINGS

Implementations are described by way of example only with reference to the attached figures.

FIG. 1 is a graph showing cycling performances of one example and one comparative example of lithium ion batteries.

FIG. 2 is a graph showing voltage-time curve and temperature-time curve of another example of a lithium ion battery being overcharged, with an inserted photograph of the overcharged lithium ion battery.

FIG. 3 is a graph showing voltage-time curve and temperature-time curve of another comparative example of a lithium ion battery being overcharged, with an inserted photograph of the overcharged lithium ion battery.

### DETAILED DESCRIPTION

A detailed description with the above drawings is made to further illustrate the present disclosure.

In one embodiment, a cathode composite material is provided. The cathode composite material comprises a cathode active material and a polymer composited with the cathode active material. The polymer can be obtained by polymerizing a maleimide type monomer with an organic diamine type compound. The polymer can be mixed uniformly with the cathode active material, or coated on a surface of the cathode active material. A mass percent of the polymer in the cathode composite material can be 0.01% to 10%, such as 0.1% to 5%.

The maleimide type monomer comprises at least one of a maleimide monomer, a bismaleimide monomer, a multimaleimide monomer, and a maleimide type derivative monomer.

The maleimide monomer can be represented by formula I:

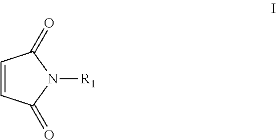

wherein R₁ is a monovalent organic substituent. More specifically, R₁ can be —R, —RNH₂R, —C(O)CH₃, —CH₂OCH₃, —CH₂S(O)CH₃, a monovalent alicyclic group, a monovalent substituted aromatic group, or a monovalent unsubstituted aromatic group, such as —C₆H₅, —C₆H₄C₆H₅, or —CH₂(C₆H₄)CH₃. R can be a hydrocarbyl with 1 to 6 carbon atoms, such as an alkyl with 1 to 6 carbon atoms. An atom, such as hydrogen, of the monovalent aromatic group can be substituted by a halogen, an alkyl with 1 to 6 carbon atoms, or a silane group with 1 to 6 carbon atoms to form the monovalent substituted aromatic group. The monovalent unsubstituted aromatic group can be phenyl, methyl phenyl, or dimethyl phenyl. An amount of benzene ring in the monovalent substituted aromatic group or the monovalent unsubstituted aromatic group can be 1 to 2.

The maleimide monomer can be selected from N-phenyl-maleimide, N-(p-methyl-phenyl)-maleimide, N-(m-methyl-phenyl)-maleimide, N-(o-methyl-phenyl)-maleimide, N-cyclohexane-maleimide, maleimide, maleimide-phenol, maleimide-benzocyclobutene, di-methylphenyl-maleimide, N-methyl-maleimide, ethenyl-maleimide, thio-maleimide, keto-maleimide, methylene-maleimide, maleimide-methyl-ether, maleimide-ethanediol, 4-maleimide-phenyl sulfone, and combinations thereof.

The bismaleimide monomer can be represented by formula II:

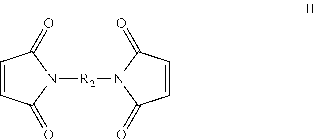

wherein R₂ is a bivalent organic substituent. More specifically, R₂ can be —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —R—Si(CH₃)₂—O—Si(CH₃)₂—R—, a bivalent alicyclic group, a bivalent substituted aromatic group, or a bivalent unsubstituted aromatic group, such as phenylene (—C₆H₄—), diphenylene (—C₆H₄C₆H₄—), substituted phenylene, substituted diphenylene, —(C₆H₄)—R₅—(C₆H₄)—, —CH₂(C₆H₄)CH₂—, or —CH₂(CH₆H₄)(O)—. R₅ can be —CH₂—, —C(O)—, —C(CH₃)₂—, —O—, —O—O—, —S—, —S—S—, —S(O)—, or —(O)S(O)—. R can be a hydrocarbyl with 1 to 6 carbon atoms, such as an alkyl with 1 to 6 carbon atoms. An atom, such as hydrogen, of the bivalent aromatic group can be substituted by a halogen, an alkyl with 1 to 6 carbon atoms, or a silane group with 1 to 6 carbon atoms to form the bivalent substituted aromatic group. An amount of benzene ring in the bivalent substituted aromatic group or the bivalent unsubstituted aromatic group can be 1 to 2.

The bismaleimide monomer can be selected from
N,N′-bismaleimide-4,4′-diphenyl-methane,
1,1′-(methylene-di-4,1-phenylene)-bismaleimide,
N,N′-(1,1′-diphenyl-4,4′-dimethylene)-bismaleimide,
N,N′-(4-methyl-1,3-phenylene)-bismaleimide,
1,1′-(3,3′-dimethyl-1,1′-diphenyl-4,4′-dimethylene)-bismaleimide,
N,N′-ethenyl-bismaleimide, N,N′-butenyl-bismaleimide,
N,N′-(1,2-phenylene)-bismaleimide, N,N′-(1,3 -phenylene)-bismaleimide,
N,N′-bismaleimide sulfide, N,N′-bismaleimide disulfide, keto-N,N′-bismaleimide,
N,N′-methylene-bismaleimide, bismaleimide-methyl-ether, 1,2-bismaleimide-1,2-glycol,
N,N′-4,4′-diphenyl-ether-bismaleimide, 4,4′-bismaleimide-diphenyl sulfone, and combinations thereof.

The maleimide type derivative monomer can be obtained by substituting a hydrogen atom of the maleimide monomer, the bismaleimide monomer, or the multimaleimide monomer with a halogen atom.

The organic diamine type compound can be represented by formula III or formula IV:

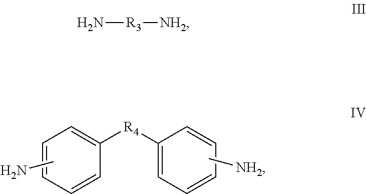

wherein R₃ is a bivalent organic substituent, and R₄ is another bivalent organic substituent.

R₃ can be —(CH₂)ₙ—, —CH₂—O—CH₂—, —CH(NH)—(CH₂)ₙ—,a bivalent alicyclic group, a bivalent substituted aromatic group, or a bivalent unsubstituted aromatic group, such as phenylene (—C₆H₄—), diphenylene (—C₆H₄C₆H₄—), substituted phenylene, or substituted diphenylene. R₄ can be —(CH₂)ₙ—, —O—, —S—, —S—S—, —CH₂—O—CH₂—, —CH(NH)—(CH₂)ₙ—, or —CH(CN)(CH₂)ₙ—. n can be 1 to 12. An atom, such as hydrogen, of the bivalent aromatic group can be substituted by a halogen, an alkyl with 1 to 6 carbon atoms, or a silane group with 1 to 6 carbon atoms to form the bivalent substituted aromatic group. An amount of benzene ring in the bivalent substituted aromatic group or the bivalent unsubstituted aromatic group can be 1 to 2.

The organic diamine type compound can comprise but is not limited to ethylenediamine, phenylenediamine, diamino-diphenyl-methane, diamino-diphenyl-ether, or combinations thereof.

A molecular weight of the polymer can be ranged from about 1000 to about 500000.

In one embodiment, the maleimide type monomer is bismaleimide, the organic diamine type compound is diamino-diphenyl-methane, and the additive is represented by formula V:

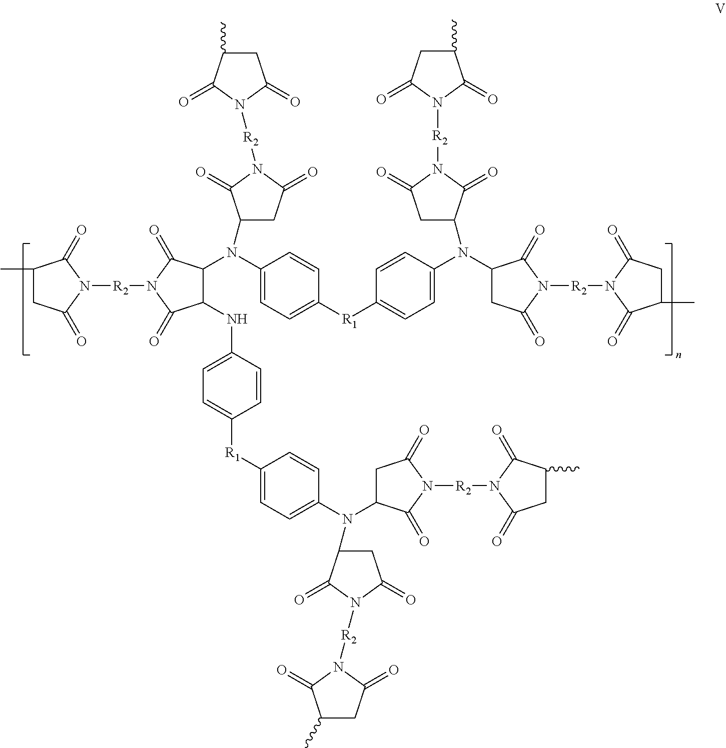

In one embodiment, a method for making the cathode composite material is provided. The method comprises polymerizing the maleimide type monomer with the organic diamine type compound to form the polymer, and compositing the polymer with the cathode active material.

A method for making the polymer comprises: dissolving the organic diamine type compound in a solvent to form a first solution of the organic diamine type compound; mixing the maleimide type monomer with the solvent, and then preheating to form a second solution of the maleimide type monomer; and adding the first solution of the organic diamine type compound to the preheated second solution of the maleimide type monomer, mixing and stirring to react adequately, and obtaining the polymer.

A molar ratio of the maleimide type monomer to the organic diamine type compound can be 1:10 to 10:1, such as 1:2 to 4:1. A mass ratio of the maleimide type monomer to the solvent in the second solution of the maleimide type monomer can be 1:100 to 1:1, such as 1:10 to 1:2. The second solution of the maleimide type monomer can be preheated to a temperature of about 30□ to about 180□, such as about 50□ to about 150□. A mass ratio of the organic diamine type compound to the solvent in the first solution of the organic diamine type compound can be 1:100 to 1:1, such as 1:10 to 1:2.

The first solution of the organic diamine type compound can be transported into the second solution of the maleimide type monomer at a set rate via a delivery pump, and then be stirred continuously for a set time to react adequately. The set time can be in a range from about 0.5 hours (h) to about 48 h, such as from about 1 h to about 24 h. The solvent can be organic solvent that dissolves the maleimide type monomer and the organic diamine type compound, such as gamma-butyrolactone, propylene carbonate, or N-methyl pyrrolidone (NMP).

In one embodiment, the polymer can be obtained firstly by polymerizing the maleimide type monomer with the organic diamine type compound. Then, the polymer can be mixed with the cathode active material, or coated on the surface of the cathode active material. In another embodiment, the second solution of the maleimide type monomer can be mixed with the cathode active material and preheated firstly, followed by adding the first solution of the organic diamine type compound, mixing, and stirring to react adequately to form the polymer directly on the surface of the cathode active material, so that the polymer can be coated more completely.

The cathode active material can be at least one of layer type lithium transition metal oxides, spinel type lithium transition metal oxides, and olivine type lithium transition metal oxides, such as olivine type lithium iron phosphate, layer type lithium cobalt oxide, layer type lithium manganese oxide, spinel type lithium manganese oxide, lithium nickel manganese oxide, and lithium cobalt nickel manganese oxide.

The cathode composite material can comprise a conducting agent and/or a binder. The conducting agent can be carbonaceous materials, such as at least one of carbon black, conducting polymers, acetylene black, carbon fibers, carbon nanotubes, and graphite. The binder can be at least one of polyvinylidene fluoride (PVDF), polyvinylidene fluoride, polytetrafluoroethylene (PTFE), fluoro rubber, ethylene oropylene diene monomer, and styrene-butadiene rubber (SBR).

In one embodiment, a lithium ion battery is provided. The lithium ion battery can comprise a cathode, an anode, a separator, and an electrolyte liquid. The cathode and the anode are spaced from each other by the separator. The cathode can further comprise a cathode current collector and the cathode composite material located on a surface of the cathode current collector. The anode can further comprise an anode current collector and an anode material located on a surface of the anode current collector. The anode material and the cathode composite material are relatively arranged and spaced by the separator.

The anode material can comprise an anode active material, and can further comprise a conducting agent and a binder. The anode active material can be at least one of lithium titanate, graphite, mesophase carbon micro beads (MCMB), acetylene black, mesocarbon miocrobead, carbon fibers, carbon nanotubes, and cracked carbon. The conducting agent can be carbonaceous materials, such as at least one of carbon black, conducting polymers, acetylene black, carbon fibers, carbon nanotubes, and graphite. The binder can be at least one of polyvinylidene fluoride (PVDF), polyvinylidene fluoride, polytetrafluoroethylene (PTFE), fluoro rubber, ethylene oropylene diene monomer, and styrene-butadiene rubber (SBR).

The separator can be polyolefin microporous membrane, modified polypropylene fabric, polyethylene fabric, glass fiber fabric, superfine glass fiber paper, vinylon fabric, or composite membrane of nylon fabric, and wettable polyolefin microporous membrane composited by welding or bonding.

The electrolyte liquid comprises a lithium salt and a non-aqueous solvent. The non-aqueous solvent can comprise at least one of cyclic carbonates, chain carbonates, cyclic ethers, chain ethers, nitriles, amides and combinations thereof, such as ethylene carbonate, diethyl carbonate, propylene carbonate, dimethyl carbonate, ethyl methyl carbonate, butylene carbonate, gamma-butyrolactone, gamma-valerolactone, dipropyl carbonate, N-methyl pyrrolidone, N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, acetonitrile, succinonitrile, methoxymethylsulfone, tetrahydrofuran, 2-methyltetrahydrofuran, epoxy propane, methyl acetate, ethyl acetate, propyl acetate, methyl butyrate, ethyl propionate, methyl propionate, 1,3-dioxolane, 1,2-diethoxyethane, 1,2-dimethoxyethane, and 1,2-dibutoxy.

The lithium salt can comprise at least one of lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium hexafluoroantimonate (LiSbF₆), lithium perchlorate (LiClO₄), Li[BF₂(C₂O₄)], Li[PF₂(C₂O₄)₂], Li[N(CF₃SO₂)₂], Li[C(CF₃SO₂)₃], and lithium bisoxalatoborate (LiBOB).

### EXAMPLES

### Example 1

4 g of bismaleimide (BMI) and 2.207 g of diamino-diphenyl-methane are dissolved in the NMP to form a solution. The oxygen is removed from the solution. The solution is heated to about 130° C. and the reaction is carried out for about 6 hours. After cooling, a product 1 represented by formula V is obtained in steps of precipitation using ethyl alcohol, washing and drying.

78% of LiNi_{1/3}Co_{1/3}Mn_{1/3}O₂, 2% of the product 1, 10% of PVDF, and 10% of conducting graphite by mass percent are mixed and dispersed by the NMP to form a slurry. The slurry is coated on an aluminum foil and vacuum dried at 120° C. for 12 hours to obtain a cathode. 1 M of LiPF₆ is dissolved in a solvent mixture of EC/DEC/EMC=1/1/1(v/v/v) to obtain an electrolyte liquid. A 2032 button battery having the cathode, the electrolyte liquid, and a lithium plate as a counter electrode is assembled, and a charge-discharge performance is tested.

### Example 2

92% of LiNi_{1/3}Co_{1/3}Mn_{1/3}O₂, 2% of the product 1, 3% of PVDF, and 3% of conducting graphite by mass percent are mixed and dispersed by the NMP to form a slurry. The slurry is coated on an aluminum foil, vacuum dried at 120° C., pressed and cut to obtain a cathode.

94% of graphite anode, 3.5% of PVDF, and 2.5% of conducting graphite by mass percent are mixed and dispersed by the NMP to form a slurry. The slurry is coated on an aluminum foil, vacuum dried at about 100° C., pressed and cut to obtain an anode. The cathode and the anode are assembled and rolled up to form a 63.5 mm×51.5 mm×4.0 mm sized soft packaged battery.

### Comparative Example 1

80% of LiNi_{1/3}Co_{1/3}Mn_{1/3}O₂, 10% of PVDF, and 10% of conducting graphite by mass percent are mixed and dispersed by the NMP to form a slurry. The slurry is coated on an aluminum foil and vacuum dried at 120° C. for 12 hours to obtain a cathode.

1 M of LiPF₆ is dissolved in a solvent mixture of EC/DEC/EMC=1/1/1(v/v/v) to obtain an electrolyte liquid. A 2032 button battery having the cathode, the electrolyte liquid, and a lithium plate as a counter electrode is assembled, and a charge-discharge performance is tested.

### Comparative Example 2

94% of LiNi_{1/3}Co_{1/3}Mn_{1/3}O₂, 3% of PVDF, and 3% of conducting graphite by mass percent are mixed and dispersed by the NMP to form a slurry. The slurry is coated on an aluminum foil, vacuum dried at about 120° C., pressed and cut to obtain a cathode.

94% of graphite anode, 3.5% of PVDF and 2.5% of conducting graphite by mass percent are mixed and dispersed by the NMP to form a slurry. The slurry is coated on an aluminum foil, vacuum dried at about 100° C., pressed and cut to obtain an anode. The cathode and the anode are assembled and rolled up to form a 63.5 mm×51.5 mm×4.0 mm sized soft packaged battery.

Electrochemical Performance Test

The batteries of example 1 and comparative example 1 are charged and discharged at a constant current rate of 0.2 C in the voltage ranging from 2.8V to 4.3V for over 50 cycles.

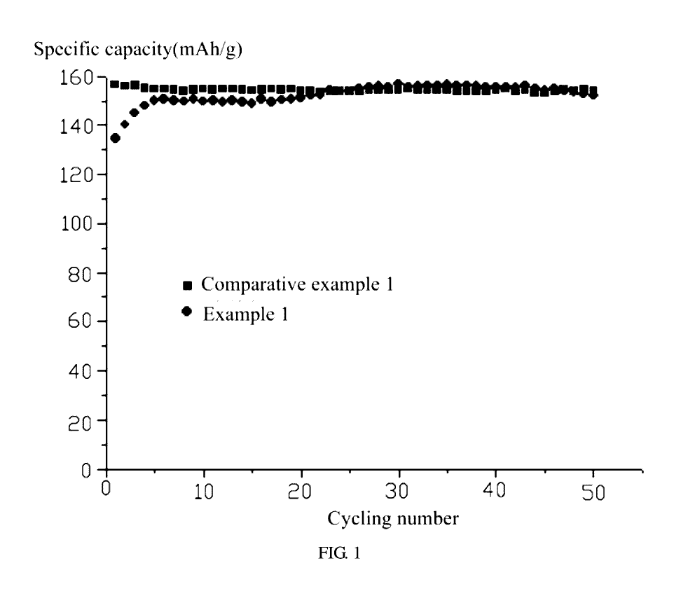

FIG. 1 is a graph showing cycling performances of example 1 and comparative example 1 of the batteries. It can be seen from FIG. 1 that the specific capacity of the battery of example 1 is slightly lower than comparative example 1. The specific capacity of the battery of example 1 is lower than comparative example 1 in the first several cycles, but consistent with comparative example 1 after a few cycles (e.g., about 25 cycles). In general, the addition of the product 1 has insignificant effect on the electrochemical and cycling performances to the battery.

Overcharge Test to the Battery

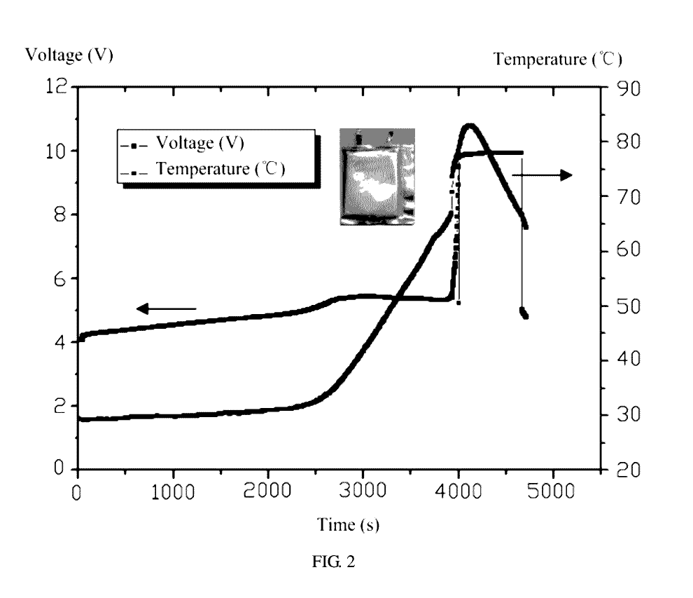

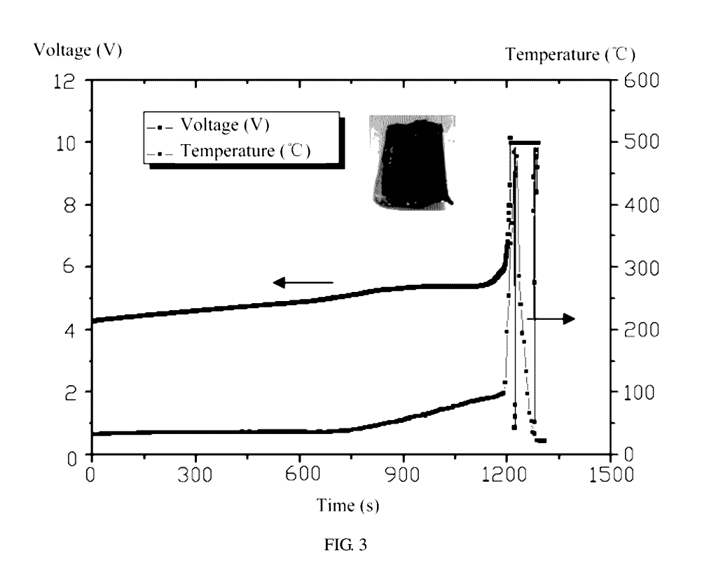

The batteries of example 2 and comparative example 2 are charged at a current rate of 1 C to a cut-off voltage of 10 V. FIG. 2 and FIG. 3 are graphs respectively showing curves of voltages and temperatures with respect to time of the overcharged batteries of example 2 and comparative example 2. The inserted figures shown in FIG. 2 and FIG. 3 are photographs of example 2 and comparative example 2 of the overcharged batteries, respectively.

It can be seen obviously from FIG. 2 that the highest temperature of the battery containing the product 1 is only about 85° C., and the battery containing the product 1 does not show remarkable deformation in the overcharging process. However, as shown in FIG. 3, the battery without the product 1 bursts into flames when it is overcharged to 8V, and the temperature thereof is up to 500° C. It can thus be concluded that the addition of the product 1 significantly improves the overcharging performance of the battery.

### Example 3

3.2 g of N-phenyl-maleimide and 2.34 g of diamino-diphenyl-methane are dissolved in the NMP to form a solution. The oxygen is removed from the solution. The solution is heated to 125° C. and the reaction is carried out for 8 hours. After cooling, a product 2 is obtained in steps of precipitation in ethyl alcohol, washing and drying.

75% of LiNi_{1/3}Co_{1/3}Mn_{1/3}O₂, 5% of the product 2, 10% of PVDF, and 10% of conducting graphite by mass percent are mixed and dispersed by the NMP to form a slurry. The slurry is coated on an aluminum foil and vacuum dried at about 120° C. for about 12 hours to obtain a cathode. 1 M of LiPF₆ is dissolved in a solvent mixture of EC/DEC/EMC=1/1/1(v/v/v) to obtain an electrolyte liquid. A 2032 button battery having a lithium plate as a counter electrode is assembled. A charge-discharge performance, and overcharge performance are tested, and the test results are listed in Table 1.

### Example 4

92% of LiNi_{1/3}Co_{1/3}Mn_{1/3}O₂, 2% of the product 2, 3% of PVDF, and 3% of conducting graphite by mass percent are mixed and dispersed by the NMP to form a slurry. The slurry is coated on an aluminum foil, vacuum dried at 120° C., pressed and cut to obtain a cathode.

94% of graphite anode, 3.5% of PVDF and 2.5% of conducting graphite by mass percent are mixed and dispersed by the NMP to form a slurry. The slurry is coated on an aluminum foil, vacuum dried at about 100° C., pressed and cut to obtain an anode. The cathode and the anode are assembled and rolled up to form a 63.5 mm×51.5 mm×4.0 mm sized soft packaged battery.

### Example 5

4 g of N,N′-ethenyl-bismaleimide and 2.75 g of diamino-diphenyl-methane are dissolved in the NMP to form a solution. The oxygen is removed from the solution. The solution is heated to about 135° C. and the reaction is carried out for about 7 hours. After cooling, a product 3 is obtained in steps of precipitation using ethyl alcohol, washing and drying.

78% of LiNi_{1/3}Co_{1/3}Mn_{1/3}O₂, 2% of the product 2, 10% of PVDF, and 10% of conducting graphite by mass percent are mixed and dispersed by the NMP to form a slurry. The slurry is coated on an aluminum foil and vacuum dried at 120° C. for 12 hours to obtain a cathode. 1 M of LiPF₆ is dissolved in a solvent mixture of EC/DEC/EMC=1/1/1(v/v/v) to obtain an electrolyte liquid. A 2032 button battery having the cathode, the electrolyte liquid, and a lithium plate as a counter electrode is assembled. A charge-discharge performance, and overcharge performance are tested, and the test results are listed in Table 1.

### Example 6

92% of LiNi_{1/3}Co_{1/3}Mn_{1/3}O₂, 2% of the product 3, 3% of PVDF, and 3% of the conducting graphite by mass percent are mixed and dispersed by the NMP to form a slurry. The slurry is coated on an aluminum foil, vacuum dried at 120° C., pressed and cut to obtain a cathode.

94% of graphite anode, 3.5% of PVDF and 2.5% of conducting graphite by mass percent are mixed and dispersed by the NMP to form a slurry. The slurry is coated on an aluminum foil, vacuum dried at 100° C., pressed and cut to obtain an anode. The cathode and the anode are assembled and rolled up to form a 63.5 mm×51.5 mm×4.0 mm sized soft packaged battery.

TABLE 1

| | Specific | |
|---|---|---|
| | capacity after 50 cycles | Overcharged to 10 V |
| Example 1 | 151 mAh/g | — |
| Example 2 | — | No significant deformation |
| Example 3 | 150 mAh/g | — |
| Example 4 | — | No significant deformation |
| Example 5 | 149 mAh/g | — |
| Example 6 | — | No significant deformation |
| Comparative | 153 mAh/g | — |
| Example 1 | | |
| Comparative | — | burning |
| Example 2 | | |

The polymer, obtained by polymerizing the maleimide type monomer with the organic diamine type compound, can improve electrode stability, thermal stability, and overcharge protection ability of the lithium ion battery with no effect on charge and discharge cycling performance by adding to the cathode material.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A cathode composite material comprising a cathode active material and a polymer composited with the cathode active material, wherein the polymer is obtained by polymerizing a maleimide type monomer with an organic diamine type compound;
the maleimide type monomer is selected from the group consisting of maleimide monomer, bismaleimide monomer, multimaleimide monomer, maleimide type derivative monomer, and combinations thereof; and
the organic diamine type compound is represented by formula III or formula IV: 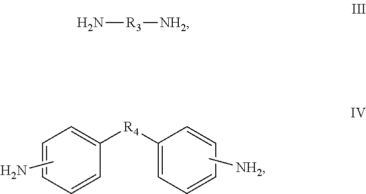
wherein R₃ is a bivalent organic substituent and R₄ is another bivalent organic substituent.

2. The cathode composite material of claim 1, wherein R₃ is selected from the group consisting of —(CH₂)ₙ—, —CH₂—O—CH₂—, —CH(NH)—(CH₂)ₙ—, phenylene, diphenylene, substituted phenylene, substituted diphenylene, and bivalent alicyclic group, R₄ is selected from the group consisting of —(CH₂)ₙ—, —O—, —S—, —S—S—, —CH₂—O—CH₂—, —CH(NH)—(CH₂)ₙ—, and —CH(CN)(CH₂)ₙ—, and n=1 to 12.

3. The cathode composite material of claim 1, wherein the organic diamine type compound is selected from the group consisting of ethylenediamine, phenylenediamine, diamino-diphenyl-methane, diamino-diphenyl-ether, and combinations thereof.

4. The cathode composite material of claim 1, wherein the maleimide monomer is represented by formula I: 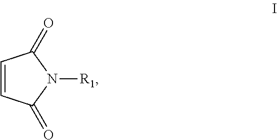
wherein R₁ is a monovalent organic substitute.

5. The cathode composite material of claim 4, wherein R₁ is selected from the group consisting of —R, —RNH₂R, —C(O)CH₃, —CH₂OCH₃, —CH₂S(O)CH₃, —C₆H₅, —C₆H₄C₆H₅, —CH₂(C₆H₄)CH₃, and monovalent alicyclic group; R is hydrocarbyl with 1 to 6 carbon atoms.

6. The cathode composite material of claim 1, wherein the maleimide monomer is selected from the group consisting of N-phenyl-maleimide, N-(p-methyl-phenyl)-maleimide, N-(m-methyl-phenyl)-maleimide, N-(o-methyl-phenyl)-maleimide, N-cyclohexane-maleimide, maleimide, maleimide-phenol, maleimide-benzocyclobutene, di-methylphenyl-maleimide, N-methyl-maleimide, ethenyl-maleimide, thio-maleimide, keto-maleimide, methylene-maleimide, maleimide-methyl-ether, maleimide-ethanediol, 4-maleimide-phenyl sulfone, and combinations thereof.

7. The cathode composite material of claim 1, wherein the bismaleimide monomer is represented by formula II: 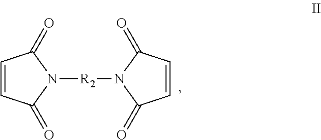
wherein R₂ is a bivalent organic substitute.

8. The cathode composite material of claim 7, wherein R₂ is selected from the group consisting of —R—, —RNH₂R—, —C(O)CH₂—, -CH₂OCH₂—, —C(O)—, —O—, —O—O—, —S—, —S—S—, —S(O)—, —CH₂S(O)CH₂—, —(O)S(O)—, -CH₂(C₆H₄)CH₂—, —CH₂(C₆H₄)(O)—, —R—Si(CH₃)₂—O—Si(CH₃)₂—R—, —C₆H₄—, —C₆H₄C₆H₄—, bivalent alicyclic group or —(C₆H₄)—R₅—(C₆H₄)—; R₅ is —CH₂—, —C(O)—, —C(CH₃)₂—, —O—, —O—O—, —S—, —S—S—, S(O)—, and —(O)S(O)—; and R is hydrocarbyl with 1 to 6 carbon atoms.

9. The cathode composite material of claim 1, wherein the bismaleimide monomer is selected from the group consisting of N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-bismaleimide sulfide, N,N′-bismaleimide disulfide, keto-N,N′-bismaleimide, N,N′-methylene-bismaleimide, bismaleimide-methyl-ether, 1,2-bismaleimide-1,2-glycol, N,N′-4,4′-diphenyl-ether-bismaleimide, 4,4′-bismaleimide-diphenyl sulfone, and combinations thereof.

10. The cathode composite material of claim 1, wherein a molecular weight of the polymer is in a range from about 1000 to about 500000.

11. The cathode composite material of claim 1, wherein a mass percent of the polymer in the cathode composite material is in a range from about 0.1% to about 5%.

12. The cathode composite material of claim 1, wherein the cathode active material comprises at least one of layer type lithium transition metal oxides, spinel type lithium transition metal oxides, and olivine type lithium transition metal oxides.

13. A lithium ion battery comprising a cathode, an anode, a separator, and an electrolyte liquid, wherein the cathode comprises a cathode composite material;
the cathode composite material comprises a cathode active material and a polymer composited with the cathode active material;
the polymer is obtained by polymerizing a maleimide type monomer with an organic diamine type compound;
the maleimide type monomer is selected from the group consisting of maleimide monomer, bismaleimide monomer, multimaleimide monomer, maleimide type derivative monomer, and combinations thereof; and
the organic diamine type compound is represented by formula III or formula IV: 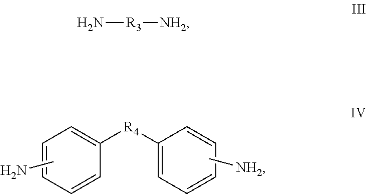
wherein R₃ is a bivalent organic substituent and R₄ is another bivalent organic substituent.

14. A method for making a cathode composite material comprising:
polymerizing a maleimide type monomer with an organic diamine type compound to obtain a polymer; and
compositing the polymer with a cathode active material;
wherein the maleimide type monomer is selected from the group consisting of maleimide monomer, bismaleimide monomer, multimaleimide monomer, maleimide type derivative monomer, and combinations thereof;
the organic diamine type compound is represented by formula III or formula IV: 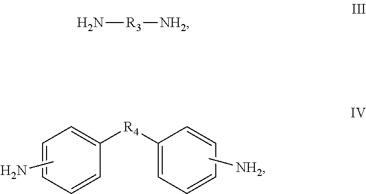
wherein R₃ is a bivalent organic substituent and R₄ is another bivalent organic substituent; and
the polymerizing the maleimide type monomer with the organic diamine type compound comprises:
dissolving the organic diamine type compound in an organic solvent to form a first solution of the organic diamine type compound;
mixing the maleimide type monomer with the organic solvent, and preheating to form a second solution of the maleimide type monomer; and
reacting the first solution of the organic diamine type compound with the second solution of the maleimide type monomer, by mixing and stirring.

15. The method of claim 14, wherein a molar ratio of the maleimide type monomer to the organic diamine type compound is in a range from about 1:2 to about 4:1.

16. The method of claim 14, wherein the second solution of the maleimide type monomer is preheated to a temperature of about 30□ to about 180□.

17. The method of claim 14, wherein the cathode active material is added in the second solution of the maleimide type monomer, and the polymer is formed directly on a surface of the cathode active material.
